(19) United States
(12) Patent Application Publication
(10) Pub. No.: US 2016/0364486 A1
(43) Pub. Date: Dec. 15, 2016

(54) Methods and Systems for Segmenting Individuals By Interest

(71) Applicant: Fractal Analytics Inc., San Mateo, CA (US)

(72) Inventors: Natwar Mall, Mumbai (IN); Sumith Balagangadharan, Thane (IN); Ankit Solanki, Mumbai (IN); Tirthankar Chakravarty, Mumbai (IN); Neha Singh, Gurgaon (IN)

(73) Assignee: FRACTAL ANALYTICS INC., San Mateo, CA (US)

(21) Appl. No.: 14/736,445

(22) Filed: Jun. 11, 2015

(51) Int. Cl. G06F 17/30

(52) U.S. Cl. CPC G06F 17/30867; G06F 17/30598; G06F 17/30958; G06F 17/3053

(57) ABSTRACT

An individualized interest graph is mapped by receiving raw data, including social media data, pertaining to the individual, extracting key terms from the raw data, querying a knowledge base with the key terms to identify uniform resource identifiers (“URIs”) in the knowledge base, identifying categories within the knowledge base that encompass the URIs, and defining the interest graph to include these categories. An analogous process can be followed to generate a segment graph. Overlap between the individualized interest graph and the segment graph can be used to segment the individual, for example to personalize a retail interaction with the individual.

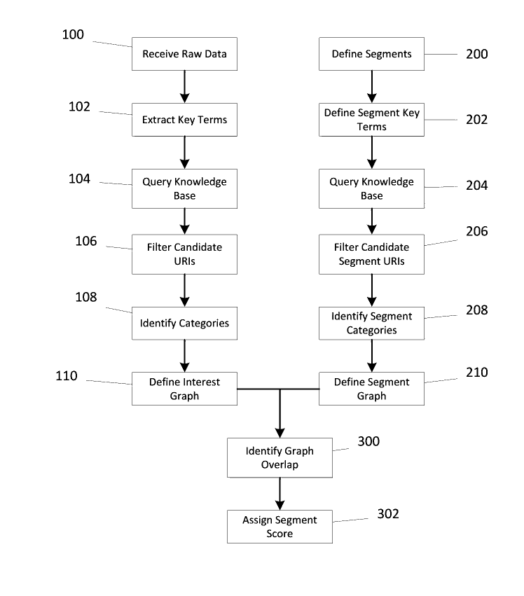

### BACKGROUND

The instant disclosure relates to data mining. In particular, the instant disclosure relates to using an individual's data to construct a profile of that individual's interests.

It is understood, for example by those of ordinary skill in the retail space, that personalized interactions with actual and potential customers can increase value. Yet, customer interactions are often driven through traditional segmentation frameworks, which have the disadvantages of being overly generalized and static.

There is a vast amount of unstructured data about individuals presently available, including, without limitation, social media data. For example, as of August 2011, Twitter users generated about 200 million tweets per day. 107 trillion emails were sent in 2010. There were 152 million blogs in 2010. These numbers are undoubtedly even larger today.

It would be desirable to leverage this data in order to personalize interactions with actual and potential customers.

### BRIEF SUMMARY

Disclosed herein is a method of mapping an interest graph of an individual, including: receiving raw data, including social media data, pertaining to the individual; extracting at least one key term from the raw data; querying a knowledge base with the at least one key term to identify at least one uniform resource identifier (“URI”) in the knowledge base; identifying one or more categories within the knowledge base encompassing the identified at least one URI; and defining the interest graph of the individual to include the identified one or more categories. Identifying one or more categories within the knowledge base encompassing the identified at least one URI can include applying graph theory to the knowledge base to identify one or more categories within the knowledge base that are within a preset number of hops from the identified at least one URI.

In embodiments, the method also includes filtering the identified at least one URI prior to identifying one or more categories within the knowledge base. Identifying one or more categories within the knowledge base encompassing the identified at least one URI can then include identifying one or more categories within the knowledge base encompassing the filtered identified at least one URI. Filtering can include discarding one or more of: an ambiguous URI, a common named entity URI, and a blacklisted URI.

According to aspects of the disclosure, the raw data pertaining to the individual can also include contextual data pertaining to the individual, such as geolocation data pertaining to the individual.

Also disclosed herein is a method of segmenting an individual by interest, including: defining an interest graph of the individual; defining at least one segment graph; identifying overlap between the interest graph of the individual and the at least one segment graph; assigning at least one segment score indicative of the identified overlap between the interest graph of the individual and a respective segment graph of the at least one segment graph. A higher segment score can be indicative of a greater degree of overlap between the interest graph of the individual and the respective segment graph of the at least one segment graph.

The step of defining at least one segment graph can include: defining at least one segment key term for the at least one segment; querying a knowledge base with the at least one segment key term to identify at least one segment URI in the knowledge base; identifying one or more segment categories within the knowledge base encompassing the identified at least one segment URI; and defining the at least one segment graph to include the identified one or more segment categories. The identified at least one segment URI can also be filtered prior to identifying one or more segment categories within the knowledge base; identifying one or more segment categories within the knowledge base encompassing the identified at least one segment URI can then include identifying one or more segment categories within the knowledge base encompassing the filtered identified at least one segment URI. Suitable filtering techniques include discarding one or more of: an ambiguous segment URI, a common named entity segment URI, and a blacklisted segment URI.

The step of identifying one or more segment categories within the knowledge base encompassing the identified at least one segment URI can include applying graph theory to the knowledge base to identify one or more segment categories within the knowledge base that are within a preset number of hops from the identified at least one segment URI.

The step of defining an interest graph of the individual can include: receiving raw data, including social media data, pertaining to the individual; extracting at least one key term from the raw data; querying a knowledge base with the at least one key term to identify at least one uniform resource identifier (“URI”) in the knowledge base; identifying one or more categories within the knowledge base encompassing the identified at least one URI; and defining the interest graph of the individual to include the identified one or more categories. The identified at least one URI can be filtered prior to identifying one or more categories within the knowledge base; identifying one or more categories within the knowledge base encompassing the identified at least one URI can then include identifying one or more categories within the knowledge base encompassing the filtered identified at least one URI. Suitable filtering techniques include discarding one or more of: an ambiguous URI, a common named entity URI, and a blacklisted URI.

The step of identifying one or more categories within the knowledge base encompassing the identified at least one URI can include applying graph theory to the knowledge base to identify one or more categories within the knowledge base that are within a preset number of hops from the identified at least one URI.

According to aspects of the disclosure, the raw data pertaining to the individual can also include geolocation data pertaining to the individual, which can also be used when defining the interest graph of the individual.

According to another aspect disclosed herein, a system for segmenting an individual by interest includes a graphing processor configured to: receive raw data pertaining to the individual as input, the raw data pertaining to the individual including social media data pertaining to the individual; extract at least one key term from the raw data pertaining to the individual; query a knowledge base with the at least one key term to identify at least one uniform resource identifier (“URI”) in the knowledge base; identify one or more categories within the knowledge base encompassing the identified at least one URI; and define an interest graph of the individual to include the identified one or more categories. The graphing processor can be further configured to: receive at least one segment key term for at least one segment as input; query the knowledge base with the at least one segment key term to identify at least one segment URI in the knowledge base; identify one or more segment categories within the knowledge base encompassing the identified at least one segment URI; and define at least one segment graph to include the identified one or more segment categories. The system can also include a scoring processor configured to assign at least one segment score to the individual, wherein the at least one segment score is indicative of a degree of overlap between the interest graph of the individual and the at least one segment graph.

The foregoing and other aspects, features, details, utilities, and advantages of the present invention will be apparent from reading the following description and claims, and from reviewing the accompanying drawings.

### BRIEF DESCRIPTION OF THE DRAWINGS

The FIGURE is a flowchart of representative steps that can be carried out according to embodiments of the instant disclosure in order to segment an individual by his or her interests.

### DETAILED DESCRIPTION

The present disclosure provides computer systems and computer-implemented methods useful to segment individuals, such as customers, by interest, for example in order to develop more personalize interactions between a merchant and the individual. In embodiments, the instant disclosure provides systems and methods for developing individualized interest graphs. For purposes of illustration, the teachings herein will be explained with reference to the creation of individualized interest graphs from social media data (e.g., data from Facebook, Twitter, LinkedIn, Instagram, Google+, and the like). It should be understood, however, that the instant teachings can likewise be practiced to good advantage in other contexts without departing from the spirit and scope of the present disclosure.

The methods disclosed herein can be carried out by one or more processors incorporated into one or more computing devices (e.g., desktop computers, laptop computers, server computers, handheld computer, and the like). Moreover, as used herein, the term “processor” refers to not only a single central processing unit (“CPU”), but also to a plurality of CPUs, commonly referred to as a parallel processing environment. It should also be understood that the methods disclosed herein can be hardware, software, and/or firmware implemented.

The FIGURE is a flowchart of representative steps that can be carried out to map an individual's interest graph according to aspects of the instant disclosure. In block 100, raw data pertaining to an individual is received. The raw data includes social media data, such as data extracted from the individual's Facebook and/or Twitter accounts. Those of ordinary skill in the art will understand how to extract social media data (e.g., by using the Facebook Graph API), such that a detailed explanation of block 100 is not necessary to the understanding of the present disclosure.

In block 102, key terms are extracted from the raw data. Those of ordinary skill in the art will understand numerous ways to extract key terms from data. For example, the raw data can be parsed for the occurrence of terms contained within a domain-specific key term glossary. As another example, the raw data can be parsed for the occurrence of terms that are unlikely to be key terms, which are referred to as “stop words.”

In still other embodiments, a part of speech tagger is applied to the raw data in order to identify nouns, verbs, and the like, and to annotate the raw data as such. Key term extraction rules can then be applied to the annotated raw data in order to extract, for example, proper nouns (e.g., by looking for words spelled with initial capital letters).

Of course, the various approaches described above, as well as other approaches that will be familiar to those of ordinary skill in the art, can be applied in combination in order to extract key terms from the raw data.

In block 104, the key terms are used to query a knowledge base, such as DBpedia. That is, an attempt is made to map each of the key terms extracted from the raw data to a uniform resource identifier (“URI”) in the knowledge base. The resultant URIs are referred to herein as “candidate URIs.”

In some embodiments, the candidate URIs are filtered in block 106. The resultant URIs are referred to herein as “filtered URIs.”

Many types of filtering are contemplated as within the scope of the present teachings. For example, ambiguous URIs can be discarded. Alternatively, ambiguous URIs can be disambiguated.

As another example, URIs designated as “blacklisted” URIs can be discarded. A user can manually blacklist any URI that the user desires not to be used to generate the individual's interest graph (for example, because the user recognizes the URI as undesirable noise). Thus, the universe of blacklisted URIs will evolve over time.

As yet another example, URIs that are common named entities (e.g., the name of a city, standing alone) can be discarded.

In block 108, the filtered URIs (or, if no filtering is applied in block 106, the candidate URIs) are used to identify categories within the knowledge base that encompass the URIs. Graph theory can be employed in block 108, where the identified categories are within a preset number of hops from the filtered URI (or candidate URI).

For example, one can consider the knowledge base to be a graph, where the data is stored in Subject Predicate Object format, with Subject and Object the nodes and Predicate the relation/edge between the nodes. The filtered URI (or candidate URI) can be referred to as the “target_URI” and the URIs linked thereto can be referred to as “NEW_URI”.

An “aura query” can be executed to extract other URIs that link to the target URI based on predefined predicates (e.g., dbpprop:industry, dbpprop:fields, dbpprop:discipline). As the ordinarily skilled artisan will appreciate from the instant disclosure, the predicates can be selected on the desired outputs. Thus, for example, where the teachings herein are applied to categorize an individual by interest(s), the predicates can be selected to ensure that the NEW_URIs returned by the aura query are category URIs, and further that they are of categories that are of interest to the user.

There are two types of URIs that can be extracted using the aura query. Incoming URIs (i.e., URI's that link into the target_URI) can be extracted using <NEW_URI> <Predicate_List> <target_URI>. Outgoing URIs (i.e., URI's to which the target_URI links) can be extracted using <target_URI> <Predicate_List> <NEW_URI>. In block 110, the individual's interest graph is defined to include the categories that result from the aura query.

As a working example, assume that the key term “Washington Redskins” was extracted from an individual's Facebook data. The corresponding URI in DBpedia is http://dbpedia.org/page/Washington_Redskins. The aura query is run to extract both incoming and outgoing NEW_URIs based on predicates that will yield valuable categories to the user (e.g., http://dbpedia.org/resources/Category:National_Football_League or http://dbpedia.org/resources/Category:Sports_in_Washington._D.C.)

As shown in the FIGURE, an analogous parallel process can be followed to define one or more segment graphs of segments that are of interest. For example, a sporting goods merchant may wish to learn of the athletic interests of potential customers in order to target advertisements (e.g., sending a promotion good for tennis equipment to someone interested in tennis). Thus, in block 200, the merchant may define a number of segments corresponding to sports for which the merchant stocks equipment (e.g., tennis, racquetball, squash, soccer, football, basketball, lacrosse, baseball, hockey).

In block 202, key terms can be defined for each segment (referred to herein as “segment key terms”). The segment key terms may be pre-populated (e.g., the merchant may specify that the key terms for baseball include the names of all 30 major league baseball teams) or extracted from a raw data set (e.g., articles about baseball may be processed using a key terming algorithm in order to extract key words).

The segment key terms can then be used in block 204 to query the knowledge base. The output of this query are candidate segment URIs, which are analogous to the candidate individual URIs discussed above. These candidate segment URIs can optionally be filtered in block 206, which yields filtered segment URIs (analogous to the filtered individual URIs discussed above).

In block 208, the filtered (or candidate) segment URIs are used to identify segment categories within the knowledge base, for example by application of the “aura” query discussed above. In block 210, the resultant segment graph is defined to include the segment categories that result from block 208.

In block 300, overlap between the individual's interest graph (as defined in block 110) and the segment graphs (as defined in block 210) is identified. For example, the intersection between the interest graph and the segment graphs can be determined.

The ordinarily skilled artisan will appreciate from the instant disclosure that a high degree of overlap between the interest graph and a particular segment graph tends to mean that the individual strongly identifies the respective segment (e.g., a high degree of overlap with the “baseball” segment would tend to indicate that the individual is a baseball fan). Thus, in addition to identifying overlap, a segment score can be assigned as a numerical indicator of the identified overlap, with high scores reflective of greater overlap (block 302).

In some aspects of the disclosure, the segment score is a value between 0 and 1, where 0 indicates no overlap and 1 indicates complete overlap. One suitable way to compute such a segment score is as follows:

Assume two segments, Seg1 and Seg2. Seg1 includes segment URIs {U1, U2, U3, U4}, while Seg2 includes segment URIs {U2, U4, U5, U6, U7, U8, U9}.

Assume further that the individual's interest graph (“IntGrph”) includes URIs {U1,U2, U3, U6, U9}.

The segment score for a given segment can be computed as the ratio of the length of the intersection between that segment and IntGrph to the length of the segment.

The intersection between Seg1 and IntGrph is {U1, U2, U3}=3.

The intersection between Seg2 and IntGrph is {U2, U6, U9}=3.

The length of Seg1 is 4.

The length of Seg2 is 7.

Thus, the segment score for Seg1 is 0.75 and the segment score for Seg2 is 0.43. This indicates that the user more closely identifies with Seg1 than Seg2. A merchant could use this information, for example, to ensure that the individual receives more advertising related to Seg1 than related to Seg2.

Numerical scores can also be translated to narrative scores or other formats. For example, segment scores between 0 and 0.3 can be called “low interest” and represented in red, segment scores between 0.3 and 0.7 can be called “moderate interest” and represented in yellow, and segment scores between 0.7 and 1 can be called “high interest” and represented in green.

Although several embodiments of this invention have been described above with a certain degree of particularity, those skilled in the art could make numerous alterations to the disclosed embodiments without departing from the spirit or scope of this invention.

For example, in addition to using social media data, the methods and systems disclosed herein can also use contextual data pertaining to the individual. In some embodiments, geolocation data pertaining to the individual can be used when defining the interest graph, identifying overlap between the interest graph and the segment graph, and/or computing a segment score.

In other embodiments, the contextual data does not pertain directly to the individual. For example, contextual data can include weather or events (e.g., the occurrence of a natural disaster or a holiday festival).

Individual interest graphs, as well as segment scores, can also be updated to account for new and/or changed data (e.g., new posts to the individual's Facebook account).

All directional references (e.g., upper, lower, upward, downward, left, right, leftward, rightward, top, bottom, above, below, vertical, horizontal, clockwise, and counterclockwise) are only used for identification purposes to aid the reader's understanding of the present invention, and do not create limitations, particularly as to the position, orientation, or use of the invention. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other.

It is intended that all matter contained in the above description or shown in the accompanying drawings shall be interpreted as illustrative only and not limiting. Changes in detail or structure may be made without departing from the spirit of the invention as defined in the appended claims.

What is claimed is:

1. A method of mapping an interest graph of an individual, the method comprising:
receiving raw data, including social media data, pertaining to the individual;
extracting at least one key term from the raw data;
querying a knowledge base with the at least one key term to identify at least one uniform resource identifier (“URI”) in the knowledge base;
identifying one or more categories within the knowledge base encompassing the identified at least one URI; and
defining the interest graph of the individual to include the identified one or more categories.

2. The method according to claim 1, wherein identifying one or more categories within the knowledge base encompassing the identified at least one URI comprises applying graph theory to the knowledge base to identify one or more categories within the knowledge base that are within a preset number of hops from the identified at least one URI.

3. The method according to claim 1, further comprising filtering the identified at least one URI prior to identifying one or more categories within the knowledge base, and wherein identifying one or more categories within the knowledge base encompassing the identified at least one URI comprises identifying one or more categories within the knowledge base encompassing the filtered identified at least one URI.

4. The method according to claim 3, wherein filtering the identified at least one URI comprises discarding one or more of: an ambiguous URI, a common named entity URI, and a blacklisted URI.

5. The method according to claim 1, wherein the raw data pertaining to the individual further comprises contextual data pertaining to the individual.

6. The method according to claim 5, wherein the contextual data pertaining to the individual comprises geolocation data pertaining to the individual.

7. A method of segmenting an individual by interest, the method comprising:
defining an interest graph of the individual;
defining at least one segment graph;
identifying overlap between the interest graph of the individual and the at least one segment graph;
assigning at least one segment score indicative of the identified overlap between the interest graph of the individual and a respective segment graph of the at least one segment graph.

8. The method according to claim 7, wherein a higher segment score is indicative of a greater degree of overlap between the interest graph of the individual and the respective segment graph of the at least one segment graph.

9. The method according to claim 7, wherein defining at least one segment graph comprises:
defining at least one segment key term for the at least one segment;
querying a knowledge base with the at least one segment key term to identify at least one segment URI in the knowledge base;
identifying one or more segment categories within the knowledge base encompassing the identified at least one segment URI; and
defining the at least one segment graph to include the identified one or more segment categories.

10. The method according to claim 9, further comprising filtering the identified at least one segment URI prior to identifying one or more segment categories within the knowledge base, and wherein identifying one or more segment categories within the knowledge base encompassing the identified at least one segment URI comprises identifying one or more segment categories within the knowledge base encompassing the filtered identified at least one segment URI.

11. The method according to claim 10, wherein filtering the identified at least one segment URI comprises discarding one or more of: an ambiguous segment URI, a common named entity segment URI, and a blacklisted segment URI.

12. The method according to claim 9, wherein identifying one or more segment categories within the knowledge base encompassing the identified at least one segment URI comprises applying graph theory to the knowledge base to identify one or more segment categories within the knowledge base that are within a preset number of hops from the identified at least one segment URI.

13. The method according to claim 7, wherein defining an interest graph of the individual comprises:
receiving raw data, including social media data, pertaining to the individual;
extracting at least one key term from the raw data;
querying a knowledge base with the at least one key term to identify at least one uniform resource identifier (“URI”) in the knowledge base;
identifying one or more categories within the knowledge base encompassing the identified at least one URI; and
defining the interest graph of the individual to include the identified one or more categories.

14. The method according to claim 13, further comprising filtering the identified at least one URI prior to identifying one or more categories within the knowledge base, and wherein identifying one or more categories within the knowledge base encompassing the identified at least one URI comprises identifying one or more categories within the knowledge base encompassing the filtered identified at least one URI.

15. The method according to claim 14, wherein filtering the identified at least one URI comprises discarding one or more of: an ambiguous URI, a common named entity URI, and a blacklisted URI.

16. The method according to claim 13, wherein identifying one or more categories within the knowledge base encompassing the identified at least one URI comprises applying graph theory to the knowledge base to identify one or more categories within the knowledge base that are within a preset number of hops from the identified at least one URI.

17. The method according to claim 13, wherein the raw data pertaining to the individual further comprises geolocation data pertaining to the individual, and wherein defining the interest graph of the individual further comprises using the geolocation data pertaining to the individual.

18. A system for segmenting an individual by interest, the system comprising a graphing processor configured to:
receive raw data pertaining to the individual as input, the raw data pertaining to the individual including social media data pertaining to the individual;
extract at least one key term from the raw data pertaining to the individual;
query a knowledge base with the at least one key term to identify at least one uniform resource identifier (“URI”) in the knowledge base;
identify one or more categories within the knowledge base encompassing the identified at least one URI; and
define an interest graph of the individual to include the identified one or more categories.

19. The system according to claim 18, wherein the graphing processor is further configured to:
receive at least one segment key term for at least one segment as input;
query the knowledge base with the at least one segment key term to identify at least one segment URI in the knowledge base;
identify one or more segment categories within the knowledge base encompassing the identified at least one segment URI; and
define at least one segment graph to include the identified one or more segment categories.

20. The system according to claim 19, further comprising a scoring processor configured to assign at least one segment score to the individual, wherein the at least one segment score is indicative of a degree of overlap between the interest graph of the individual and the at least one segment graph.
